(19) United States
(12) Patent Application Publication
(10) Pub. No.: US 2025/0091271 A1
(43) Pub. Date: Mar. 20, 2025

(54) MAGNETIC CLAMPING APPARATUS AND INJECTION MOLDING APPARATUS

(71) Applicant: KOSMEK Ltd., Kobe-shi (JP)

(72) Inventor: Masakazu YOSHIDA, Kobe-shi (JP)

(21) Appl. No.: 18/883,423

(22) Filed: Sep. 12, 2024

(30) Foreign Application Priority Data
Sep. 14, 2023 (JP) 2023-149665

(51) Int. Cl. B29C 45/64; B29C 45/76; B29C 45/80

(52) U.S. Cl. CPC B29C 45/64; B29C 45/7653; B29C 45/768; B29C 45/80; B29C 2045/645; B29C 2945/76096; B29C 2945/76157; B29C 2945/76488; B29C 2945/76642

(57) ABSTRACT

A magnetic clamping apparatus can be switched, by a reversal of a polarity of a first magnet, between an unclamping state in which a first mold is not clamped on an attraction face of a first magnetic plate 6 and a clamping state in which it is clamped on the attraction face. If a first operation is performed with respect to the magnetic clamping apparatus, a clamping operation of switching from the unclamping state into the clamping state is performed on condition that a proximity sensor is detecting proximity of the first mold. If a second operation that is different from the first operation is performed, the clamping operation is performed on condition that the proximity sensor is not detecting the proximity of the first mold.

### TECHNICAL FIELD

The present disclosure relates to a magnetic clamping apparatus that uses magnetism to hold an object to be clamped on an attraction face.

### BACKGROUND ART

A magnetic clamping apparatus of this type is disclosed, for example, in PTL 1. The magnetic clamping apparatus of PTL 1 includes more than one magnetic attraction unit that fixes a mold and a detection means for detecting an operation state of the magnetic clamping apparatus. PTL 1 also mentions a case in which the magnetic clamping apparatus includes a proximity sensor.

PTL 1: Japanese Patent Application Publication No. 2005-515080

### SUMMARY

In order to obtain a strong attractive force in a magnetic clamping apparatus, it is important that there is no space between an object to be clamped and an attraction face. Therefore, in a case where the magnetic clamping apparatus includes a proximity sensor, an interlock control which prohibits a clamping operation unless the proximity sensor detects that the object to be clamped is in proximity may be performed.

However, depending on conditions, such as the shape of the object to be clamped or the position of the proximity sensor, it may be necessary to perform the clamping operation with the object to be clamped not being in proximity to the proximity sensor. In such a case, the interlock control as described above decreases convenience.

The present disclosure is made in view of the situation described above and its purpose is to provide a magnetic clamping apparatus that can flexibly perform a clamping operation according to a shape of an object to be clamped while confirming contact between the object to be clamped and an attraction face in order to ensure enough clamping force.

A first aspect of the present disclosure provides a magnetic clamping apparatus with a configuration as described below. That is, the magnetic clamping apparatus holds an object to be clamped on an attraction face using magnetism. The magnetic clamping apparatus includes a holding member, a first magnet, a second magnet, an electromagnetic coil, and a proximity sensor. The attraction face is formed on the holding member. The first magnet and the second magnet are arranged at the holding member. The electromagnetic coil reverses a polarity of the first magnet with a current flowing through it. The proximity sensor detects proximity of the object to be clamped to the attraction face. The magnetic clamping apparatus is switched between an unclamping state and a clamping state by a reversal of the polarity of the first magnet.

In the unclamping state, magnetic flux from the first magnet and magnetic flux from the second magnet do not emerge on the attraction face. In the clamping state, the magnetic flux from the first magnet and the magnetic flux from the second magnet emerge on the attraction face. If a first operation is performed, a clamping operation of switching from the unclamping state into the clamping state is performed on condition that the proximity sensor is detecting the proximity of the object to be clamped. If a second operation that is different from the first operation is performed, the clamping operation is performed on condition that the proximity sensor is not detecting the proximity of the object to be clamped.

Accordingly, since the first operation is performed in normal cases and the clamping operation is performed on condition that the proximity sensor detects the proximity of the object to be clamped to the attraction face, the clamping can be performed securely. On the other hand, there could be a case where it is difficult to detect the object to be clamped by the proximity sensor depending on the conditions, such as the shape of the object to be clamped or the position of the proximity sensor. In such a case, the second operation is performed and the clamping operation is performed on condition that the object is not detected. Therefore, the object to be clamped can be clamped flexibly in various situations.

In the above-described magnetic clamping apparatus, it is preferable to include a configuration as follows. That is, if the clamping operation has been performed based on the first operation, an abnormality in the clamping state is detected when the proximity sensor ceases detecting the proximity of the object to be clamped after the clamping operation. If the clamping operation has been performed based on the second operation, a result of detection made by the proximity sensor after the clamping operation is ignored in detection of an abnormality in the clamping state.

Accordingly, the consistent monitoring can be performed even after the clamping operation compatibly that the clamping operation by the second operation is performed on condition that the proximity sensor does not detect the object to be clamped.

In the above-described magnetic clamping apparatus, it is preferable to include a configuration as follows. That is, the magnetic clamping apparatus includes a detection coil that detects a change of magnetic flux when the object to be clamped moves with respect to the attraction face. If the clamping operation has been performed based on the first operation, an abnormality in the clamping state is detected when the proximity sensor ceases detecting the proximity of the object to be clamped or the detection coil detects the change of the magnetic flux after the clamping operation. If the clamping operation has been performed based on the second operation, an abnormality in the clamping state is detected when the detection coil detects the change of the magnetic flux after the clamping operation.

Accordingly, when the clamping operation is performed by the first operation, the clamping state can be monitored by multiple means using both the proximity sensor and the detection coil. On the other hand, when the clamping operation is performed by the second operation, the clamping state can be properly monitored using the detection coil.

A second aspect of the present disclosure provides an injection molding apparatus that performs injection molding using a mold that is fixed with the magnetic clamping apparatus.

Accordingly, an injection molding apparatus capable of holding a mold flexibly in various situations using magnetism can be achieved.

### BRIEF DESCRIPTION OF THE DRAWINGS

FIG. 1 is a front view showing an overall configuration of an injection molding apparatus according to one embodiment of the present disclosure.

FIG. 2 is a side view showing a configuration of a first magnetic plate.

FIG. 3 is a cross-sectional view of a first magnetic plate.

FIG. 4 is a schematic diagram showing a released state of a first magnetic plate.

FIG. 5 is a schematic diagram showing a locked state of a first magnetic plate.

FIG. 6 is a block diagram showing an electrical configuration of a magnetic clamping apparatus.

FIG. 7 is a diagram showing a configuration of an avoidance switch.

FIG. 8 is a front view showing a configuration of an operating apparatus.

FIG. 9 is an enlarged front view showing a situation in the middle of a process of attaching a mold to an injection molding apparatus.

FIG. 10 is an enlarged front view showing a situation right before a clamping operation by a magnetic clamping apparatus.

### DETAILED DESCRIPTION

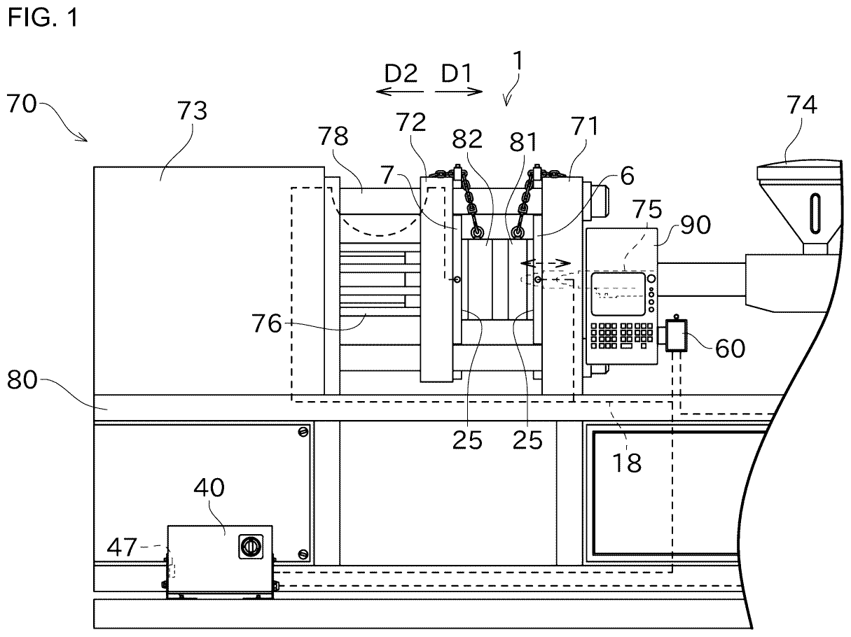

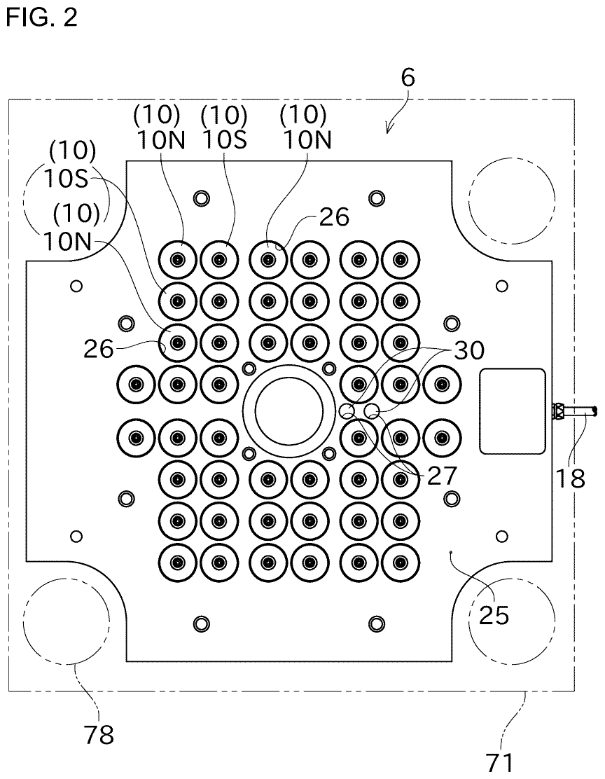

Embodiments of the present disclosure will be described below with reference to the drawings FIG. 1 is a front view showing an overall configuration of an injection molding apparatus 70 according to one embodiment of the present disclosure. FIG. 2 is a side view showing a configuration of a first magnetic plate 6.

The injection molding apparatus 70 shown in FIG. 1 includes a fixed platen 71, a movable platen 72, a mold clamping unit 73, a hopper 74, a heating cylinder 75, and an ejector 76. Furthermore, the injection molding apparatus 70 includes a magnetic clamping apparatus 1. The magnetic clamping apparatus 1 is used to detachably fix a first mold 81 to the fixed platen 71 and a second mold 82 to the movable platen 72.

The injection molding apparatus 70 includes a main frame 80 which is formed in a shape elongated in a horizontal direction. The fixed platen 71 and the mold clamping unit 73 are fixed to the main frame 80. The movable platen 72 is supported by a guide rod 78 in such a way that it can slide along the longitudinal direction of the main frame 80. The fixed platen 71 and the movable platen 72 are so arranged that they face each other in the longitudinal direction of the main frame 80.

The mold clamping unit 73 includes an actuator not shown in the drawings. The configuration of the actuator may be determined as desired. For example, it may be a motor or a hydraulic cylinder. The mold clamping unit 73 can transmit the driving force of the actuator to the movable platen 72 to move the movable platen 72 in directions approaching and away from the fixed platen 71. In the following description, a direction in which the movable platen 72 approaches the fixed platen 71 may be referred to as a mold clamping direction D1 and a direction in which it moves away from the fixed platen 71 may be referred to as a mold opening direction D2.

The hopper 74 and the heating cylinder 75 are attached to the main frame 80. The hopper 74 can store granular synthetic resin material to be used as raw material for molded products. The lower end of the hopper 74 is connected to the heating cylinder 75. The heating cylinder 75 is formed to be hollow. A screw not shown in the drawings is arranged inside the heating cylinder 75.

An actuator not shown in the drawings is connected to the heating cylinder 75. The actuator can move the heating cylinder 75 between an extended position at which it protrudes toward the movable platen 72 from the fixed platen 71 and a retracted position. When the heating cylinder 75 protrudes from the fixed platen 71, the interior space of the heating cylinder 75 is connected to a hollow, not shown in the drawings, inside the first mold 81 and the second mold 82 formed when they are closed. The synthetic resin material supplied to the heating cylinder 75 is melted by the heat, extruded by the screw, and supplied to the above-mentioned hollow. In this manner, the heating cylinder 75 functions as a nozzle to discharge the molten material.

After injection molding is finished, the ejector 76 takes out the molded product from the first mold 81 and the second mold 82 that are open.

The magnetic clamping apparatus 1 includes a first magnetic plate (a holding member) 6, a second magnetic plate (a holding member) 7, a controller 40, and an operating apparatus 60.

The first magnetic plate 6 is fixed to the fixed platen 71 by a bolt, not shown in the drawings. Similarly, the second magnetic plate 7 is fixed to the movable platen 72 by a bolt, not shown in the drawings. The first magnetic plate 6 and the second magnetic plate 7 are so arranged that they face each other in the direction of the movement of the movable platen 72.

Each of the first magnetic plate 6 and the second magnetic plate 7 includes an attraction face 25 that is formed flatly. The first mold 81 and the second mold 82, which are the targets of the clamping operation by the magnetic clamping apparatus 1, are composed of magnetic material, for example, iron.

The first magnetic plate 6 can be switched between a locked state and a released state. In the locked state, magnetic flux is generated on the attraction face 25 of the first magnetic plate 6 and the first mold 81 is attracted onto the attraction face 25 by magnetic force. In the released state, the generation of the magnetic flux on the attraction face 25 is cancelled and the first mold 81 is released from the attraction. The second magnetic plate 7 can similarly be switched between the locked state and the released state.

Since the configurations of the first magnetic plate 6 and the second magnetic plate 7 are substantially the same, the configuration of the first magnetic plate 6 will be described below as a representative.

The first magnetic plate 6 is formed as a plate. One face of the first magnetic plate 6 in the thickness direction is fixed to the fixed platen 71 and the flat attraction face 25 is formed on the opposite face.

The first magnetic plate 6 includes more than one magnetic pole element 10 and more than one proximity sensor 30.

The magnetic pole elements 10 are arranged side by side along the attraction face 25 in a grid, as shown in FIG. 2. Each of the magnetic pole elements 10 is formed as a cylinder. The same number of recesses 26 as that of the magnetic pole elements 10 are formed on the first magnetic plate 6. Each recess 26 forms a circular opening on the attraction face 25. Each magnetic pole element 10 is so arranged that it is embedded in the corresponding recess 26. An end face of the magnetic pole element 10 on one side in the axial direction composes of the attraction face 25 of the first magnetic plate 6.

Two types, namely a north pole type and a south pole type, of magnetic pole elements 10 are arranged at the first magnetic plate 6. The north pole type means that the pole facing to the attraction face 25 side in a first magnet 11, which is described below, is the north pole and the south pole type means that this pole is the south pole. The magnetic pole elements 10 are arranged at the first magnetic plate 6 in such a way that the types of two adjacent magnetic pole elements 10 in a width direction or a height direction are opposite.

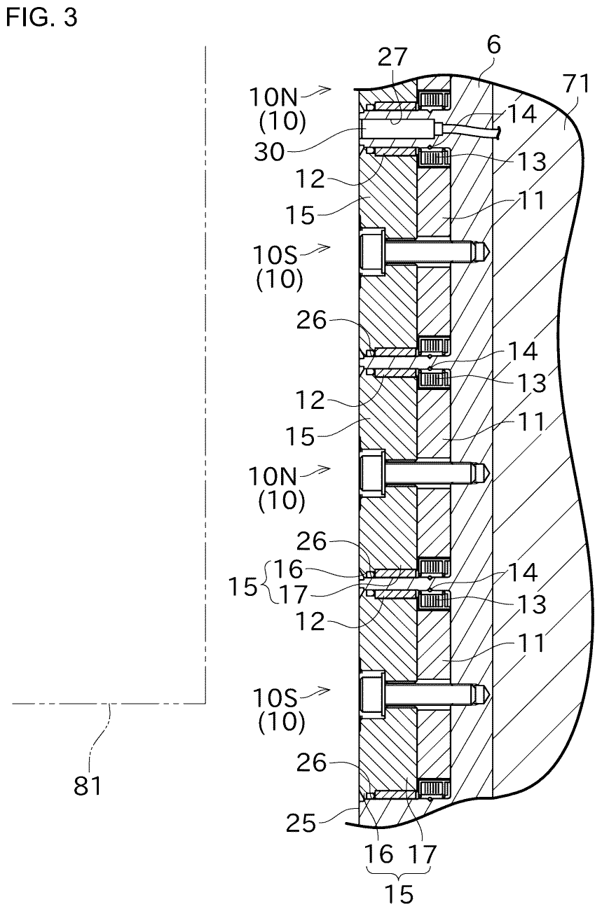

The north pole type magnetic pole element 10N will be described in detail below. As shown in FIG. 3, the north pole type magnetic pole element 10N includes the first magnet 11, a second magnet 12, an electromagnetic coil 13, a detection coil 14, and a fixing member 15. The first magnet 11, the second magnet 12, the electromagnetic coil 13, the detection coil 14, and the fixing member 15 are all housed inside the recess 26.

The first magnet 11 is configured as a permanent magnet, for example, an alnico magnet. The first magnet 11 is formed in the shape of a disc and its magnetization direction coincides with its thickness direction. In the north pole type magnetic pole element 10N, the first magnet 11 is so arranged that its north pole faces to the attraction face 25 side and its south pole faces to the opposite side.

The second magnet 12 is configured as a permanent magnet, for example, a neodymium magnet. The second magnet 12 is formed in the shape of a cylinder and its magnetization direction coincides with its radial direction. The second magnet 12 is arranged around the outer periphery of a shaft portion 17 of the fixing member 15, which is described below. In the north pole type magnetic pole element 10N, the second magnet 12 is so arranged that its north pole faces radially outward and the south pole faces radially inward.

The electromagnetic coil 13 is comprised of a long and thin electrical conductor wound in a cylindrical shape. The electromagnetic coil 13 is arranged around the outer periphery of the disk-shaped first magnet 11. The electromagnetic coil 13 is arranged side by side with the second magnet 12 in the axial direction of the magnetic pole element 10. The electromagnetic coil 13 is electrically connected to the controller 40 via a cable 18. The magnetic poles of the first magnet 11 can be reversed by passing an electric current through the electromagnetic coil 13 and applying a magnetic field with sufficient strength whose magnetization direction is opposite of the magnetization direction of the first magnet 11.

The detection coil 14 is comprised of a long and thin electrical conductor wound in a circular shape. The detection coil 14 is fixed along the inner periphery of the recess 26. The detection coil 14 detects magnetic flux passing through its internal space. In the present embodiment, the number of turns of the detection coil 14 is substantially one, but it may be two or more.

The fixing member 15 is formed in an approximate cylindrical shape. As shown in FIG. 3, the fixing member 15 includes a flange portion 16 with a larger diameter and the shaft portion 17 with a smaller diameter. The diameter of the flange portion 16 substantially coincides with the diameter of the opening of the recess 26. The flange portion 16 fills the opening of the recess 26. The shaft portion 17 is arranged adjacent to the first magnet 11 in the axial direction of the magnetic pole element 10.

The proximity sensor 30 a non-contacting sensor and it may be configured as, for example, a known semiconductor switch. The same number of sensor recesses 27 as that of the proximate sensors 30 are formed on the first magnetic plate 6. Each sensor recess 27 forms a circular opening on the attraction face 25. Each proximity sensor 30 is so arranged that it is embedded in the corresponding sensor recess 27. The detection portion of the proximity sensor 30 is arranged close to the opening of the sensor recess 27. The proximity sensor 30 turns into an ON-state if the first mold 81, which is a target to be detected, is so close that it contacts with the attraction face 25 and otherwise it turns into an OFF-state.

In the south pole type magnetic pole element 10S, the magnetization directions of the first magnet 11 and the second magnet 12 are all opposite to those in the north pole type magnetic pole element 10N. Except for this point, the configuration of the south pole type magnetic pole element 10S is the same as the north pole type magnetic pole element 10N.

Next, the released state and the locked state of the first magnetic plate 6 will be described below. The released state can be reworded as an unclamping state and the locked state can be reworded as a clamping state.

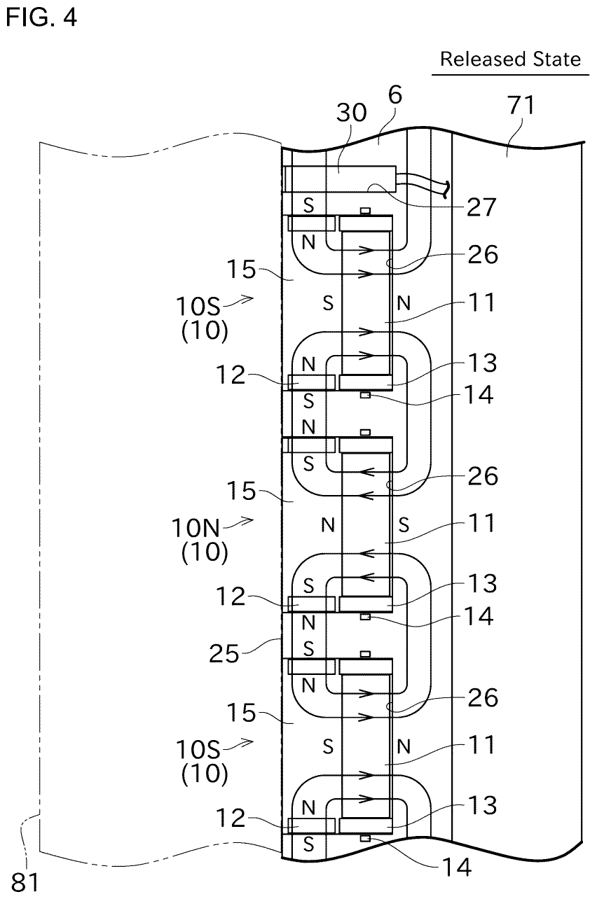

In the released state, the magnetic circuit at the first magnetic plate 6 is formed as shown in FIG. 4. Specifically, in the released state, no current flows through the electromagnetic coil 13. Therefore, when focusing on a certain north pole type magnetic pole element 10N, the magnetic flux emerged from the north pole of the first magnet 11 passes through the second magnet 12, then it passes through the neighboring south pole type magnetic pole element 10S in the order of the second magnet 12 to the first magnet 11, and then it enters the south pole of the first magnet 11 of the aforementioned magnetic pole element 10N. In this manner, since the magnetic circuit is formed to loop inside the first magnetic plate 6 in the released state, no magnetic flux is generated on the attraction face 25. Therefore, the first mold 81 is not attracted.

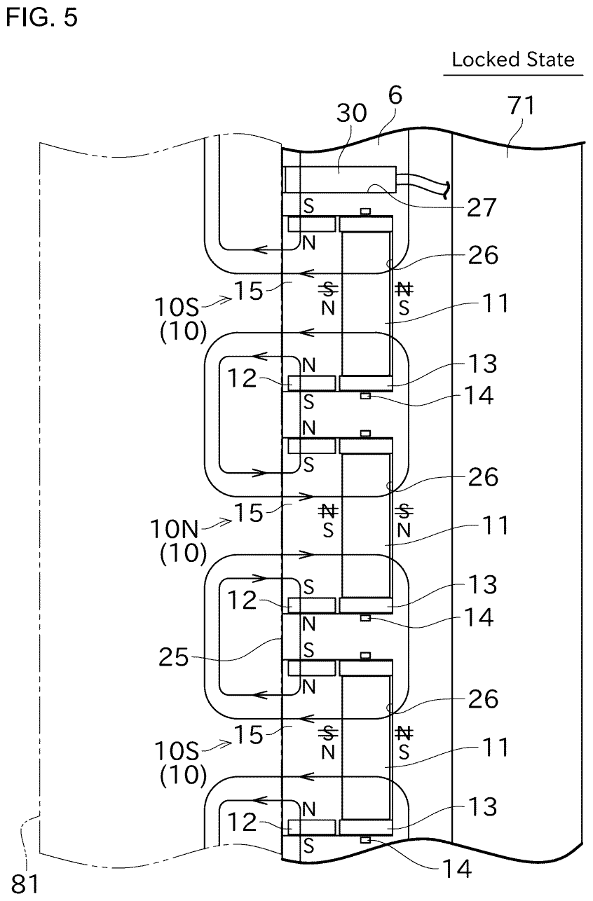

When a current flows through the electromagnetic coil 13 in a state shown in FIG. 4, the first magnetic plate 6 is switched to the locked state shown in FIG. 5. Specifically, with respect to all of the magnetic pole elements 10 that the first magnetic plate 6 includes, the polarity of the first magnet 11 is reversed due to the DC electricity flows through the electromagnetic coil 13. Accordingly, the magnetic pole on the face of the first magnet 11 facing to the attraction face 25 side and the magnetic pole on the inner periphery of the second magnet 12 become identical. As a result, when focusing on a certain north pole type magnetic pole element 10N, the magnetic flux emerged from the north pole of the second magnet 12 passes through the second magnet 12 of the neighboring south pole type magnetic pole element 10S, then it passes through the first mold 81, and then it enters the south pole of the second magnet 12 from which it emerged. In the same magnetic pole element 10N, the magnetic flux emerged from the north pole of the first magnet 11 whose polarity is reversed passes through the first magnet 11 of the neighboring south pole type magnetic pole element 10S, then it passes through the first mold 81, and then it enters the south pole of the first magnet 11 of the aforementioned magnetic pole element 10N. In this state, both the magnetic flux based on the first magnet 11 and the second magnet 12 of the magnetic pole element 10N emerge on the attraction face 25. As a result, the first mold 81 is attracted to the attraction face 25 by magnetic force.

Once the first mold 81 is attracted onto the attraction face 25, even if the supplement of current to the electromagnetic coil 13 is stopped, the locked state is stably maintained by the above-described magnetic lines. Accordingly, the energy can be saved. To return the first magnetic plate 6 from the locked state to the released state, a DC current in the opposite direction compared to the above current should be applied to the all of the electromagnetic coils 13 that the first magnetic plate 6 includes.

The second magnetic plate 7 attracts and holds the second mold 82 on the attraction face 25 by the same principle as the first magnetic plate 6. Since the second magnetic plate 7 is configured substantially the same as the first magnetic plate 6, the description thereof is omitted.

Next, the controller 40 and the operating apparatus 60 will be described below.

The controller 40 is configured as a known computer and includes a CPU, a ROM, a RAM, and the like. The controller 40 is electrically connected to the operating apparatus 60 and a molding apparatus controller 90. The molding apparatus controller 90 is a computer that controls each part of the injection molding apparatus 70 and operates in coordination with the controller 40 of the magnetic clamping apparatus 1.

The controller 40 includes a current controller 41, a current acquirer 42, a proximity sensor state acquirer 43, a clamping state monitor 44, an abnormality output unit 45, an interlock controller 46, and an avoidance switch 47.

The current controller 41 controls the current flowing through the electromagnetic coil 13 that each of the first magnetic plate 6 and the second magnetic plate 7 includes.

The current acquirer 42 acquires the current flowing through the detection coil 14 of each of the first magnetic plate 6 and the second magnetic plate 7. An induced current in a direction that interferes the change of the magnetic flux passing through is generated in the detection coil 14. The magnitude of the current acquired by the current acquirer 42 is sampled at an appropriate frequency and an integral calculation is performed. As a result, the amount of change of the magnetic flux passing through the detection coil 14 can be obtained.

The proximity sensor state acquirer 43 acquires the state of the proximity sensor 30 that each of the first magnetic plate 6 and the second magnetic plate 7 includes.

The clamping state monitor 44 monitors the clamping states of the first magnetic plate 6 and the second magnetic plate 7 based on the current flowing through the detection coil 14 and the state of the proximity sensor 30.

The abnormality output unit 45 outputs an abnormality detection signal to the molding apparatus controller 90 when the clamping state monitor 44 detects an abnormality with respect to the first magnetic plate 6 and the second magnetic plate 7.

The interlock controller 46 performs an interlock control in the magnetic clamping apparatus 1 by, for example, exchanging signals between the controller 40 and the molding apparatus controller 90.

The interlock control related to the mold clamping of the first mold 81 and the second mold 82 will be described below. The molding apparatus controller 90 outputs a mold clamping completion signal to the controller 40 when it detects the state in which the first mold 81 and the second mold 82 are completely clamped. The detection of the mold clamped state can be made by a position sensor not shown in the drawings arranged at the injection molding apparatus 70. The interlock controller 46 prohibits the clamping operation and the unclamping operation with respect to the first magnetic plate 6 and the second magnetic plate 7 unless the mold clamping completion signal is input by the molding apparatus controller 90. Accordingly, since it can be ensured that the first mold 81 and the second mold 82 are removed only in the mold clamped state, thus the first mold 81 and the second mold 82 can be prevented from an unintentional drop.

The interlock control related to the proximity sensor 30 will be described below. The interlock controller 46 prohibits the clamping operation by the first magnetic plate 6 unless the proximity sensor 30 that the first magnetic plate 6 includes is detecting the first mold 81 and in the ON-state. Since the clamping operation can be prevented from being performed with a gap between the attraction face 25 and the first mold 81, the first mold 81 can be clamped stably and strongly.

The interlock control related to the retraction of the heating cylinder 75 will be described below. The molding apparatus controller 90 outputs a heating cylinder retraction completion signal to the controller 40 when it detects the state in which the heating cylinder 75 is retracted enough in a direction away from the fixed platen 71. The detection of the retraction state can be made by a position sensor not shown in the drawings arranged at the injection molding apparatus 70. The interlock controller 46 prohibits the clamping operation and the unclamping operation with respect to the first magnetic plate 6 and the second magnetic plate 7 unless the heating cylinder retraction completion signal is input by the molding apparatus controller 90. Accordingly, for example, the first mold 81 and the heating cylinder 75 can be prevented from being colliding with each other and damaging each other when the first mold 81 is removed.

Hereinafter, the interlock control related to mold clamping may be referred to as “the mold clamping interlock control” and the interlock control related to the detection made by the proximity sensor may be referred to as “the proximity interlock control”.

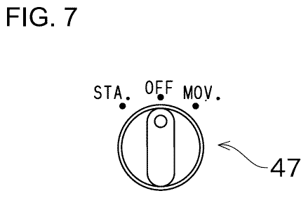

The avoidance switch 47 is operated in order to disable the above-described mold clamping interlock control. The avoidance switch 47 is configured as a selector switch with three positions as shown in FIG. 7. By rotating the avoidance switch 47, an operator can instruct the controller 40 one setting selected from three settings related to the mold clamping interlock control. The first position corresponds to an instruction to perform the mold clamping interlock control with respect to both the first magnetic plate 6 and the second magnetic plate 7. The second position corresponds to an instruction to avoid the mold clamping interlock control with respect to the first magnetic plate 6. The third position corresponds to an instruction to avoid the mold clamping interlock control with respect to the second magnetic plate 7. The avoidance of the interlock control is not recommended in principle and the second position and the third position are selected only in an exceptional situation.

The operating apparatus 60 is arranged at a different position from the position of the controller 40. The operating apparatus 60 displays various situations related to the magnetic clamping apparatus 1 and receives instructions with respect to the magnetic clamping apparatus 1 from the operator. The operating apparatus 60 functions as an input-output apparatus between the controller 40 and the operator.

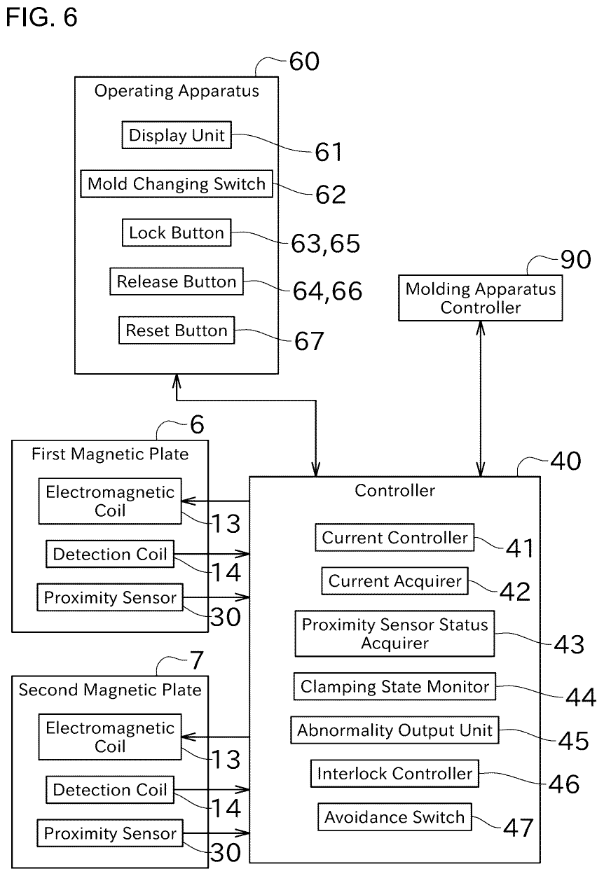

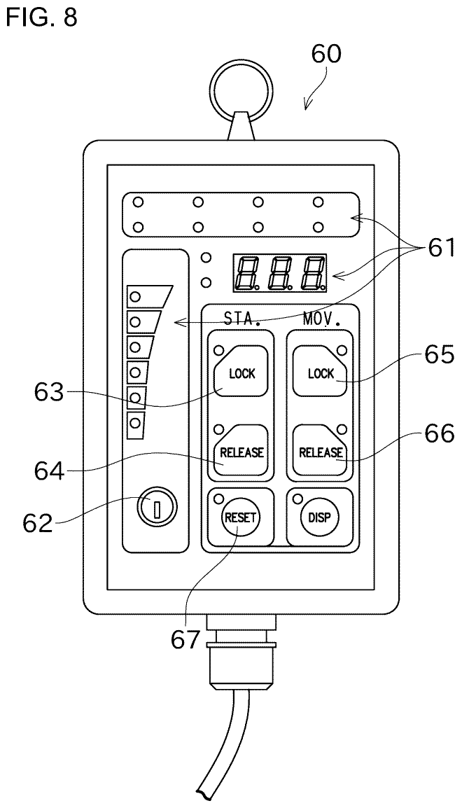

As shown in FIG. 6 and FIG. 8, the operating apparatus 60 includes a display unit 61, a mold changing switch 62, lock buttons (clamping operation units) 63, 65, release buttons (unclamping operation units) 64, 66, a reset button (alarm cancelling operation unit) 67.

The display unit 61 is comprised of a LED lamp, 7-segment LED, or the like. The display unit 61 can display information related to the magnetic clamping apparatus 1. The information that can be displayed by the display unit 61 includes an alarm display that indicates that a situation to be attended is arising in the magnetic clamping apparatus 1.

The mold changing switch 62 is an operating component for the operator to instruct that the mold is to be changed. The mold changing switch 62 can be switched between ON and OFF. The operation on the lock buttons 63, 65, the release buttons 64, 66, and the like is valid only when the mold changing switch 62 is turned ON. To prevent an accidental operation, the mold changing switch 62 is configured as a key switch that can be operated only when a key is inserted.

The lock buttons 63 and 65 are the operating components for the operator to instruct the clamping operation. Two lock buttons 63 and 65 are arranged each of them corresponding to the first magnetic plate 6 and the second magnetic plate 7.

The release buttons 64 and 66 are the operating components for the operator to instruct the unclamping operation. Two release buttons 64 and 66 are arranged similarly as the lock buttons 63 and 65.

The reset button 67 is the operating component for the operator to instruct to cancel an alarm when the alarm is generated with respect to the magnetic clamping apparatus 1.

Next, the clamping operation for fixing the first mold 81 on the first magnetic plate 6 will be described below. In the following description is based on the normal case in which it is chosen by the avoidance switch 47 that the mold clamping interlock is to be performed with respect to both the first magnetic plate 6 and the second magnetic plate 7.

Before the clamping operation is instructed, the injection molding apparatus 70 is preliminarily turned into the mold open state by the molding apparatus controller 90. Also, the heating cylinder 75 is preliminarily moved to the retracted position under the control of the molding apparatus controller 90.

The first magnetic plate 6 is in the released state shown in FIG. 4 and the second magnetic plate 7 is also in the released state. In the controller 40 that the magnetic clamping apparatus 1 includes, the current controller 41 performs a control in such a way that no current flows through the electromagnetic coils 13 at all of the magnetic pole elements 10 that the first magnetic plate 6 and the second magnetic plate 7 include.

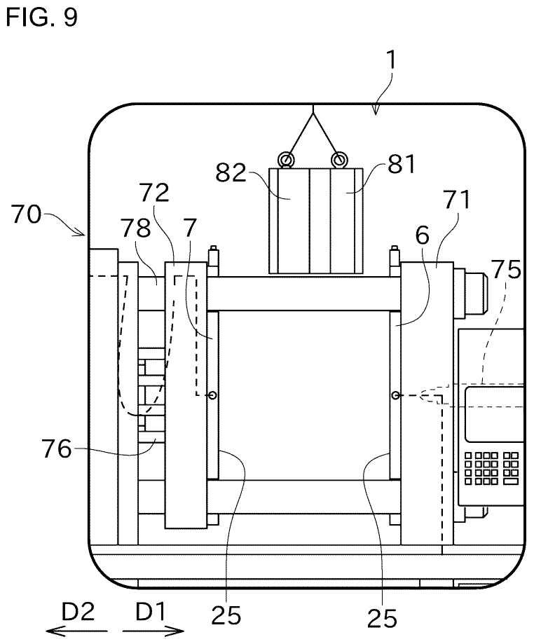

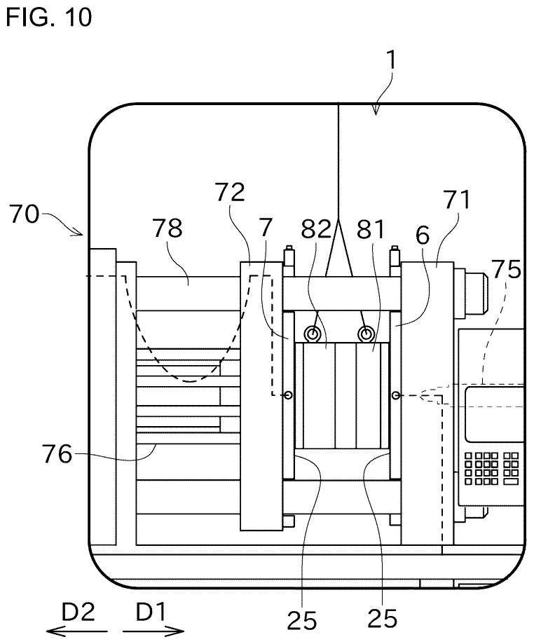

Next, the operator suspends the first mold 81 and the second mold 82 by suitable means (for example, by a crane) and brings them into the injection molding apparatus 70 as shown in FIG. 9. After the first mold 81 and the second mold 82 are suitably positioned, the operator appropriately operates the injection molding apparatus 70 to turn it into the mold clamped state. As a result, as shown in FIG. 10, the first mold 81 comes into contact with the attraction face 25 of the first magnetic plate 6 and the second mold 82 comes into contact with the attraction face 25 of the second magnetic plate 7.

The operator then turns the mold changing switch 62 of the operating apparatus 60 ON and further presses the lock button 63 to instruct the controller 40 to switch the first magnetic plate 6 into the locked state.

When the controller 40 detects this button operation, the interlock controller 46 confirms the input of the mold clamping completion signal from the molding apparatus controller 90.

If the mold clamping completion signal has been input from the molding apparatus controller 90 to the controller 40, the interlock controller 46 checks the state of the proximity sensor 30 of the first magnetic plate 6 with the proximity sensor state acquirer 43. If the proximity sensor 30 is in the ON state, the interlock controller 46 permits switching to the locked state.

If switching to the locked state is permitted, the current controller 41 of the controller 40 applies a current to the electromagnetic coils 13 of the first magnetic plate 6. As a result, the first magnetic plate 6 is switched from the released state shown in FIG. 4 into the locked state shown in FIG. 5. In this manner, the clamping state in which the first magnetic plate 6 holds the first mold 81 by magnetic force is achieved. After the clamping operation is completed, the supplement of current to the electromagnetic coils 13 is stopped.

During the process of the current flow through the electromagnetic coil 13 of the first magnetic plate 6, the amount of change of the magnetic flux that passes through the detection coil 14 is calculated based on the current value of the detection coil 14. The amount of change in the magnetic flux corresponds to the magnitude of the attraction force. If the amount of change in the magnetic flux falls below the predetermined threshold, the controller 40 displays an alarm on the display unit 61.

Next, the operator presses the lock button 65 to instruct the controller 40 to switch the second magnetic plate 7 into the locked state. The same control as above is performed and the second magnetic plate 7 is switched into the locked state. In this manner, the clamping state in which the second magnetic plate 7 holds the second mold 82 by magnetic force is achieved. The operator then turns the mold changing switch 62 OFF.

After that, the injection molding using the first mold 81 and the second mold 82 is performed at the injection molding apparatus 70.

In the state after the clamping operation (including the state during the injection molding operation), the sufficient magnitude of the attraction force is acting between the first mold 81 and the first magnetic plate 6. Therefore, normally, the first mold 81 does not move with respect to the first magnetic plate 6. However, it is possible that the first mold 81 moves with respect to the first magnetic plate 6 or the first magnetic plate 6 gets separated from the first mold 81 for some reason, such as an unexpected strong force is applied to the first mold 81.

After the clamping operation, the current flowing through the detection coil 14 of the first magnetic plate 6 is acquired by the current acquirer 42 and constantly monitored by the clamping state monitor 44. If the first mold 81 moves with respect to the first magnetic plate 6, the magnetic flux passes through the detection coil 14 changes and the induced current is generated in the detection coil 14. The integral value of the current value indicates that the attraction force lost due to the movement of the first mold 81 or other factors. When the clamping state monitor 44 detects that the integral value of the current value has exceeded a threshold, the abnormality output unit 45 immediately outputs a signal indicating that an abnormality in the clamping state is detected. The abnormality in the clamping state may be determined simply based on the current value omitting the integral calculation of the current value.

In parallel with the above-described monitoring on the current, the status of the proximity sensor 30 of the first magnetic plate 6 is acquired by the proximity sensor status acquirer 43 and constantly monitored by the clamping state monitor 44. If the first mold 81 gets separated from the first magnetic plate 6, the proximity sensor 30 switches into the OFF-state from the ON-state. If the clamping state monitor 44 detects that the proximity sensor 30 has switched into the OFF-sate, the abnormality output unit 45 immediately outputs a signal indicating that an abnormality in the clamping state is detected.

With respect to the second magnetic plate 7, the clamping state monitor 44 also performs the similar monitoring on the clamping state.

If an abnormality in the clamping state is detected, a sign that indicates the occurrence of the abnormality is displayed on the display unit 61 of the operating apparatus 60. When the molding apparatus controller 90 receives the signal indicating the abnormality in the clamping state is detected from the controller 40, it performs the control in order to, for example, immediately stop the injection molding operation. Accordingly, incidents such as the fall of the first mold 81 can be prevented.

Next, the unclamping operation for detaching the first mold 81 from the first magnetic plate 6 will be described below.

The operator attaches the first mold 81 and the second mold 82 being clamped by the magnetic clamping apparatus 1 to the above-mentioned crane.

The operator then turns the mold changing switch 62 of the operating apparatus 60 ON and further presses the release button 64 to instruct the controller 40 to switch the first magnetic plate 6 into the released state.

When the controller 40 detects this button operation, the interlock controller 46 confirms the completion of the mold clamping and the completion of the retraction of the heating cylinder 75. When the unclamping operation is permitted by the interlock controller 46, the current controller 41 applies a current to the electromagnetic coil 13 of the first magnetic plate 6 in an opposite direction compared to in the clamping operation. As a result, the first magnetic plate 6 is switched into the released state and the clamping is cancelled.

The operator then presses the release button 66 to instruct the controller 40 to switch the second magnetic plate 7 into the released state. The same control as described above is performed and the second magnetic plate 7 is switched into the released state. In this manner, the clamping related to the second magnetic plate 7 is also cancelled.

With this state, the operator takes out the first mold 81 and the second mold 82 suspended by the crane from the injection molding apparatus 70.

Next, a first special mode related to the avoidance of the mold clamping interlock control will be described below.

Normally, the clamping operation must be performed in the mold clamped state as described above. However, for some reason, such as an abnormality in a mold occurred at the injection molding apparatus 70, it may not be possible to perform mold clamping.

Even in such situation, if it is still necessary to have the first magnetic plate 6 to perform the clamping operation, for example, the operator rotates the avoidance switch 47 in advance to choose the avoidance of the mold clamping interlock with respect to the first magnetic plate 6.

The operator then turns the mold changing switch 62 ON and presses the lock button 63 related to the first magnetic plate 6.

In accordance with the setting by the avoidance switch 47, the interlock controller 46 does not confirm that the mold clamping completion signal has been input to the controller 40. Therefore, the clamping operation can be performed without the mold clamping completion signal input to the controller 40.

Next, a second special mode related to the proximity interlock control will be described below.

Normally, the clamping operation must be performed with the proximity sensor 30 detecting the first mold 81 or the second mold 82. However, for some reason, such as that an opening formed on the first mold 81 or the second mold 82 is positioned facing the proximity sensor 30, it is possible that the proximity sensor 30 does not turn into the ON-state even when the molds are contacting with the attraction face 25 at right positions.

Even in such situation, if it is still necessary to have the first magnetic plate 6 to perform the clamping operation, for example, the operator operates the avoidance switch 47 similarly as in the above-described first special mode to choose the avoidance of the mold clamping interlock with respect to the first magnetic plate 6. Furthermore, the operator turns the mold changing switch 62 ON and presses the lock button 63 related to the first magnetic plate 6 while pressing the reset button 67.

When the controller 40 detects this special operation, it permits switching to the locked state on condition, contrary to the normal practice, that the proximity sensor 30 is in the OFF-state. Although the operation for the avoidance of the mold clamping interlock control has been performed on the avoidance switch 47, this operation is merely for convenience. Therefore, in this second special mode, the interlock controls (including the mold clamping interlock control) except for the proximity interlock control are performed as usual.

In this second special mode, the first magnetic plate 6 clamps the first mold 81 with the proximity sensor 30 not detecting the first mold 81. Therefore, after the clamping operation, the clamping state monitor 44 does not monitor the clamping state based on the result of detection made by the proximity sensor 30. The monitoring of the clamping state is performed based only on the current that flows through the detection coil 14.

Accordingly, the degrees of freedom of the shape of the first mold 81 increases and thus flexible clamping of various shapes of the first mold 81 can be achieved.

The control in the second special mode by which the clamping operation is permitted on condition that the proximity sensor 30 is in the OFF-state should be performed exceptionally because it lowers the stability of the clamping. In this regard, the reset button 67 cannot remain pressed unless a finger is contacting it. Therefore, to instruct the magnetic clamping apparatus 1 to perform the clamping operation in the second special mode, it is required to press the lock button 63 while pressing the reset button 67 each time. Thus, each time the clamping operation is performed, the operator can be made aware of that it is a special operation.

Although the operation described above is related to the first magnetic plate 6, switching into the locked state with respect to the second magnetic plate 7 on condition that the proximity sensor 30 is in the OFF-state can be permitted by performing the substantially same operation with respect to the second magnetic plate 7.

As described above, the magnetic clamping apparatus 1 holds, for example, the first mold 81 on the attraction face 25 of the first magnetic plate 6 using magnetism. The magnetic clamping apparatus 1 includes the first magnetic plate 6, the first magnet 11, the second magnet 12, the electromagnetic coil 13, and the proximity sensor 30. The attraction face 25 is formed on the first magnetic plate 6. The first magnet 11 and the second magnet 12 are arranged at the first magnetic plate 6. The electromagnetic coil 13 reverses the polarity of the first magnet 11 with a current flowing through it. The proximity sensor 30 detects the proximity of the first mold 81 to the attraction face 25. The magnetic clamping apparatus 1 is switched between the unclamping state (FIG. 4) and the clamping state (FIG. 5) by the reversal of the polarity of the first magnet 11. In the unclamping state, the magnetic flux from the first magnet 11 and the magnetic flux from the second magnet 12 do not emerge on the attraction face 25. In the clamping state, the magnetic flux from the first magnet 11 and the magnetic flux from the second magnet 12 emerge on the attraction face 25. If the operation of selecting the setting to perform the mold clamping interlock control by the avoidance switch 47 and pressing the lock button 63 is performed, the clamping operation of switching from the unclamping state into the clamping state is performed on condition that the proximity sensor 30 is detecting the proximity of the first mold 81 and is in the ON-state. If the operation of selecting the setting to avoid the mold clamping interlock control with respect to the first magnetic plate 6 by the avoidance switch 47 and pressing the lock button 63 while pressing the reset button 67 is performed, the clamping operation is performed on condition that the proximity sensor 30 is not detecting the proximity of the first mold 81 and is in the OFF-state.

Accordingly, since the operation of simply pressing the lock button 63 is performed in normal cases and the clamping operation is performed on condition that the proximity sensor 30 detects the proximity of the first mold 81 to the attraction face 25, the clamping can be performed securely. On the other hand, there could be a case where it is difficult to detect the first mold 81 by the proximity sensor 30 depending on the conditions, such as the shape of the first mold 81 or the position of the proximity sensor 30. In such a case, the operation described with the above-mentioned second special mode is performed and the clamping operation is performed on condition that the proximity sensor 30 is not detecting the first mold 81. Therefore, the first mold 81 can be clamped flexibly in various situations.

In the magnetic clamping apparatus 1 of the present embodiment, if the clamping operation has been performed based on the operation of selecting the setting to perform the mold clamping interlock control by the avoidance switch 47 and pressing the lock button 63, an abnormality in the clamping state is detected when the proximity sensor 30 ceases detecting the proximity of the first mold 81 and turns into the OFF-state after the clamping operation. On the other hand, if the clamping operation has been performed based on the operation of selecting the setting to avoid the mold clamping interlock control with respect to the first magnetic plate 6 by the avoidance switch 47 and pressing the lock button 63 while pressing the reset button 67, the result of detection made by the proximity sensor 30 after the clamping operation is ignored in detection of the abnormality in the clamping state.

Accordingly, the consistent monitoring can be performed even after the clamping operation compatibly that the clamping operation is performed on condition that the proximity sensor 30 does not detect the first mold 81 when the clamping operation is performed by the operation described with the second special mode.

The magnetic clamping apparatus 1 of the present embodiment includes the detection coil 14 that detects a change of the magnetic flux when the first mold 81 moves with respect to the attraction face 25. If the clamping operation has been performed based on the operation of selecting the setting to perform the mold clamping interlock control by the avoidance switch 47 and pressing the lock button 63, an abnormality in the clamping state is detected when the proximity sensor 30 ceases detecting the proximity of the first mold 81 and turns into the OFF-state or the detection coil 14 detects the change of the magnetic flux after the clamping operation. If the clamping operation has been performed based on the operation of selecting the setting to avoid the mold clamping interlock control with respect to the first magnetic plate 6 by the avoidance switch 47 and pressing the lock button 63 while pressing the reset button 67, an abnormality in the clamping state is detected when the detection coil 14 detects the change of the magnetic flux after the clamping operation.

Accordingly, when the clamping operation is performed by the operation of simply pressing the lock button 63, the clamping state can be monitored by multiple means using both the proximity sensor 30 and the detection coil 14. On the other hand, when the clamping operation is performed by the operation described by the operation described with the second special mode, the clamping state can be properly monitored based on the detection coil 14.

The injection molding apparatus 70 of the present embodiment performs infection molding using a mold that is fixed with the magnetic clamping apparatus 1.

Accordingly, the injection molding apparatus capable of holding a mold flexibly in various situations using magnetism can be achieved.

Although the preferred embodiment of the present disclosure has been described above, the above-described configuration can be modified, for example, as follows. Such a modification may be made singularly or made in combination with any other modification.

The magnetic clamping apparatus may be so modified that it performs operations as follows. That is, in a case where the operation of selecting the setting to perform the mold clamping interlock control by the avoidance switch 47 and pressing the lock button 63 is performed, whether the proximity sensor 30 is in the ON-state or in the OFF-state does not affect the permission of the clamping operation (in other words, the interlock controller 46 does not perform the proximity interlock control). After the clamping operation, an abnormality in the clamping state is detected if the proximity sensor 30 turns into the OFF-state from the ON-state or if the detection coil 14 detects the change of the magnetic flux. This control is effective in cases where the proximity sensor 30 is often unable to detect the mold before the clamping operation.

One coil may function as both the electromagnetic coil 13 and the detection coil 14. The detection coil 14 may be arranged at only some of the magnetic pole elements 10.

The avoidance switch 47 may be arranged at the operating apparatus 60. The operating apparatus 60 and the controller 40 may be configured integrally.

The operation for instructing the magnetic clamping apparatus 1 to clamp is not limited to the operations as described above. For example, the operation of pressing the lock button 63 while pressing a suitable button other than the reset button 67 may be performed.

The number of the magnetic pole elements 10 and the proximity sensor 30 may be suitably changed. One of the first magnetic plate 6 and the second magnetic plate 7 may be omitted.

The magnetic clamping apparatus 1 may be applied to a machine other than the injection molding apparatus 70. The magnetic clamping apparatus 1 may be configured to clamp an object other than the mold, for example a workpiece to be processed, by using magnetism.

### DESCRIPTION OF THE REFERENCE NUMERALS

1 Magnetic clamping apparatus
6 First magnetic plate (Holding member)
7 Second magnetic plate (Holding member)
11 First magnet
12 Second magnet
13 Electromagnetic coil
14 Detection coil
25 Attraction face
30 Proximity sensor
70 Injection molding apparatus
81 First mold (Object to be clamped)
82 Second mold (Object to be clamped)

1. A magnetic clamping apparatus that holds an object to be clamped on an attraction face using magnetism, comprising:
a holding member, the attraction face being formed on the holding member;
a first magnet arranged at the holding member;
a second magnet arranged at the holding member;
an electromagnetic coil reversing a polarity of the first magnet with a current flowing through it; and
a proximity sensor detecting proximity of the object to be clamped to the attraction face,
wherein the magnetic clamping apparatus is switched by a reversal of the polarity of the first magnet between an unclamping state in which magnetic flux from the first magnet and magnetic flux from the second magnet do not emerge on the attraction face and a clamping state in which the magnetic flux from the first magnet and the magnetic flux from the second magnet emerge on the attraction face,
wherein, if a first operation is performed, a clamping operation of switching from the unclamping state into the clamping state is performed on condition that the proximity sensor is detecting the proximity of the object to be clamped, and
wherein, if a second operation that is different from the first operation is performed, the clamping operation is performed on condition that the proximity sensor is not detecting the proximity of the object to be clamped.

2. The magnetic clamping apparatus according to claim 1, wherein, if the clamping operation has been performed based on the first operation, an abnormality in the clamping state is detected when the proximity sensor ceases detecting the proximity of the object to be clamped after the clamping operation, and wherein, if the clamping operation has been performed based on the second operation, a result of detection made by the proximity sensor after the clamping operation is ignored in detection of an abnormality in the clamping state.

3. The magnetic clamping apparatus according to claim 2, comprising:
a detection coil detecting a change of magnetic flux when the object to be clamped moves with respect to the attraction face,
wherein, if the clamping operation has been performed based on the first operation, an abnormality in the clamping state is detected when the proximity sensor ceases detecting the proximity of the object to be clamped or the detection coil detects the change of the magnetic flux after the clamping operation, and
wherein, if the clamping operation has been performed based on the second operation, an abnormality in the clamping state is detected when the detection coil detects the change of the magnetic flux after the clamping operation.

4. An injection molding apparatus that performs injection molding using a mold that is fixed with a magnetic clamping apparatus according to claim 1.
